(19) United States
(12) Patent Application Publication
(10) Pub. No.: US 2022/0370269 A1
(43) Pub. Date: Nov. 24, 2022

(54) EXERCISE PEDAL WHEEL ACCESSORY AND ATTACHMENT BRACKET FOR WHEELCHAIRS

(71) Applicant: Alice Fay Jones, Sarasota, FL (US)

(72) Inventor: Alice Fay Jones, Sarasota, FL (US)

(21) Appl. No.: 17/325,990

(22) Filed: May 20, 2021

(51) Int. Cl. A61G 5/02; A61G 5/10; A61G 5/12; A61G 5/04

(52) U.S. Cl. CPC A61G 5/027; A61G 5/1051; A61G 5/128; A61G 5/042; A61G 5/022; A61G 2200/34

(57) ABSTRACT

A pedal wheel accessory (2) and bracket (19) for attaching such a wheeled device to a wheelchair (1), the bracket having an elongated bar (20) having a top and bottom end with a connecting collar (7) at the top end for attachment to the post (6) of the wheeled device and a T-connector (8) at the bottom end of the elongated bar for attachment to a wheelchair, said T-connector having a crossbar (21) with clamps (9) at each end for attachment to bars (18) on the chassis of a wheelchair.

### FIELD OF THE INVENTION

This invention relates to wheelchairs and more particularly is an attachable/detachable pedal wheel and electric motor wheel accessory that is adjustable to universally and removably attach to any wheelchair allowing wheelchair bound individuals to exercise their legs.

### BACKGROUND OF THE INVENTION

Wheelchair bound individuals may find it difficult to exercise their legs and lower body extremities due to loss of muscle mass and the lack of such exercise often results in atrophy of the legs, thereby making it more likely that they will be confined to and/or dependent upon wheelchairs which in turn limits their mobility. Although physical therapy may help wheelchair bound individuals to again become ambulatory on their own it is usually not enough.

Past attempts to address this include some pedal accessories for wheelchairs, but most are fixedly attached to a wheelchair and a user must remain stationary in the same location during use. Still other past attempts require modification to a wheelchair and cannot be easily and quickly removed when not in use.

Thus, a need exists for a pedal wheel accessory for a wheelchair to provide exercise for a wheelchair bound individual which can be easily and quickly attached and removed from any size wheelchair, that does not require modification to a wheelchair and can make a wheelchair ambulatory so wheelchair bound individuals can pedal anywhere under their own power.

### SUMMARY OF THE INVENTION

The primary object of the present invention is to provide a pedal wheel accessory for a wheelchair to enable wheelchair bound individuals to exercise their legs and lower body extremities.

Another object of the present invention is to provide such an accessory that can be easily attached and removed from a wheelchair.

Even another object of the present invention is to provide such an accessory that does not require a wheelchair to be modified to use it.

A further object of the present invention is to provide such an accessory that is adjustable and universal to fit any size wheelchair.

An even further object of the present invention is to provide such an accessory that enables wheelchair bound individuals to travel using their own leg power as well as being convertible to accommodate paraplegic individuals with an electric motorized wheel.

The present invention fulfills the above and other objects by providing an accessory for a wheelchair having a wheel, a pedal in a center of the wheel, a post onto which the wheel is mounted at a bottom of the post and a steering wheel on top of the post and a bracket for attaching such a wheeled device to a wheelchair. The bracket has an elongated bar having a top and bottom end with a connector at the top end for attachment to the post of the wheeled device and a T-connector at the bottom end of the elongated bar for attachment to a wheelchair, said T connector having a forward bar that connects to the elongated bar and a rear crossbar connected at each end to a bar on the chassis or undercarriage of a wheelchair.

The crossbar of the T-connector has at least one section containing a plurality of apertures and a single end snap button for adjusting a width of the crossbar to fit various sizes of wheelchairs. Similarly, the elongated connecting bar of the attachment bracket also has a plurality of apertures proximate on the bottom end and the forward bar of the T-connector contains a single end snap button for insertion into one of the plurality of apertures on the elongated bar to adjust the distance between the wheelchair and the wheeled device. A plate extending from a rear of the crossbar of the T-connector to hold a battery connector to an electric wheel attachment. The wheeled device converts into what is known as the UNI-WHEEL.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective side view of the pedal wheel accessory of the present invention attached to a wheelchair for use;

FIG. 2 is a top view of an attachment bracket of the present invention used to attach a pedal wheel exercise device to a wheelchair;

FIG. 3 is a top view of the T section of the attachment bracket of the present invention used to attach a pedal wheel exercise device and or electric wheel to a wheelchair; and

FIG. 4 is an enlarged perspective view of the accessory bracket of the present invention attached to the chassis or under carriage of a wheelchair.

### DESCRIPTION OF THE PREFERRED EMBODIMENTS

For purposes of describing the preferred embodiment, the terminology used in reference to the numbered accessories in the drawings is as follows:
1. wheelchair
2. wheeled device (UNI-WHEEL)
3. pedal
4. wheel/electric wheel
5. steering wheel
6. post
7. post connector collar
8. T connector
9. wheelchair bar attachment clamp
10. adjustment apertures on lower end of connecting bar
11. single end snap button
12. a, b. side legs of connecting bracket
13. side leg adjustment apertures
14. holding plate
15. pivot sleeve
16. nut and bolt
17. clamp adjustment apertures
18. wheelchair chassis bar
19. attachment bracket, generally
20. upper section of connecting bar
21. crossbar of T-connector
22. lower section of connecting bar

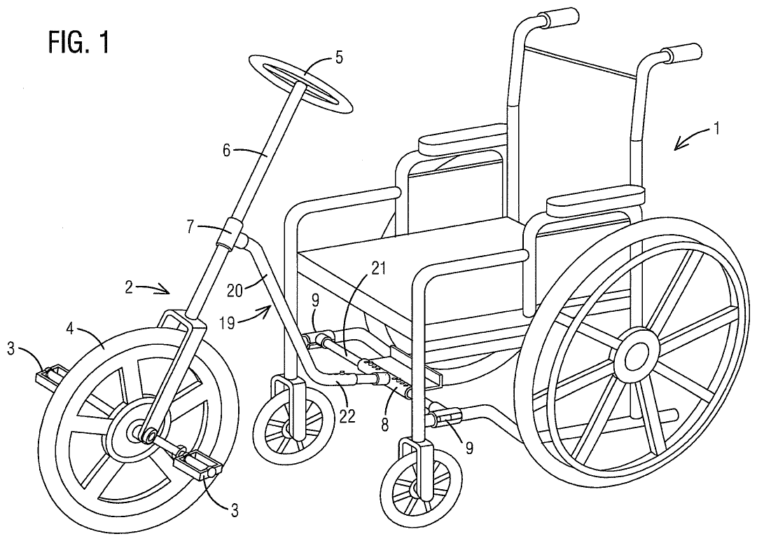

Referring now to the FIG. 1, a perspective side view of a wheelchair 1 is illustrated showing a uni-wheel type wheeled device 2 having a post 6 to which a wheel 4 is rotatably connected with foot pedals 3 and steering wheel 5. The attachment bracket 19 has a substantially S-shaped connecting bar 20 having a connecting collar 7 that securely fits around the post 6 of the wheeled device 2. The bar 20 adjustably connects to a T-connector 8 that connects to a crossbar 21 having clamps 9 that connect to chassis bars 18 on the wheelchair 1.

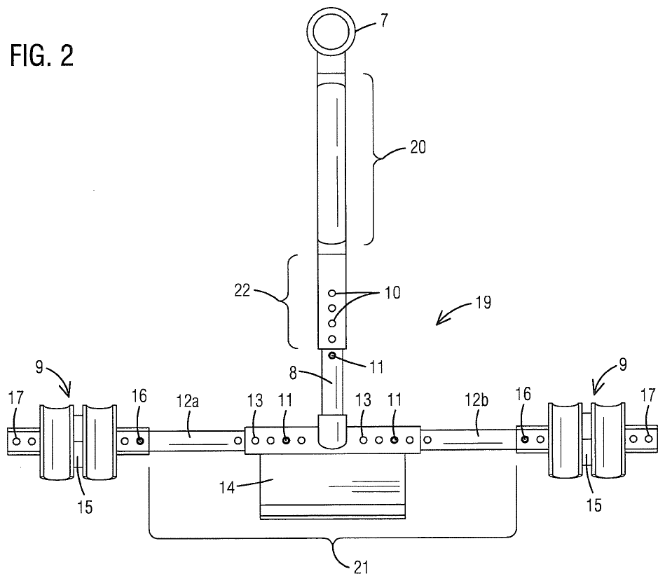

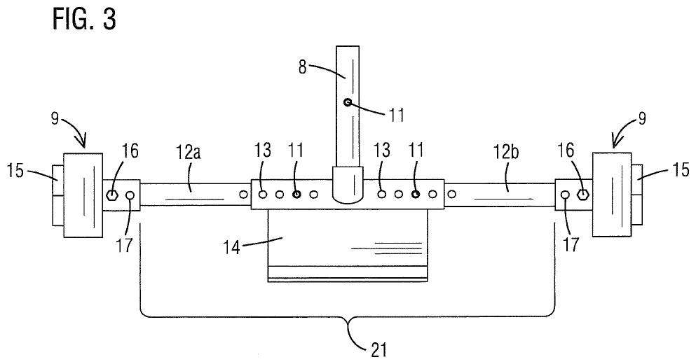

FIGS. 2 and 3 best illustrate the attachment bracket 19 and T-connector 8 and components of the present invention that are employed to attach the wheeled device 2 to the wheelchair 1. The attachment bracket 19 is substantially S-shaped having an upwardly sloping forward section 20 that has the connecting collar 7 that wraps around the post 6 of the wheeled device and a rear lower section 20 that connects to the T-connector 8 of the attachment bracket 19. The lower section 22 may have a plurality of apertures 10 that when used in conjunction with a leaf spring snap button in the T-connector 8 allow the distance between a wheelchair 1 and a wheeled device 2 to be adjusted as desired depending on the leg length of a wheelchair-bound individual. The T-connector 8 has a crossbar 21 which may be formed of multiple telescoping legs 12a and 12b that with the use of apertures 13 and leaf spring snap buttons 11 can be used to adjust the width and thus fit a range of sizes of wheelchairs 1. The bracket 19 is in turn connected to the wheelchair 1 by clamps 9 which are preferably of a two-part clam-shell type of clamp that are connected by pivot sleeves 15 and secured to a bar on the chassis of a wheelchair by nuts and bolts 16 so the bracket and wheeled device can be easily and quickly installed and removed from the wheelchair 1 when not in use without modifying the wheelchair. The bracket 19 may have a plate 14 attached to a rear of the crossbar 21 to hold an item, such as a battery if the wheeled accessory is motorized.

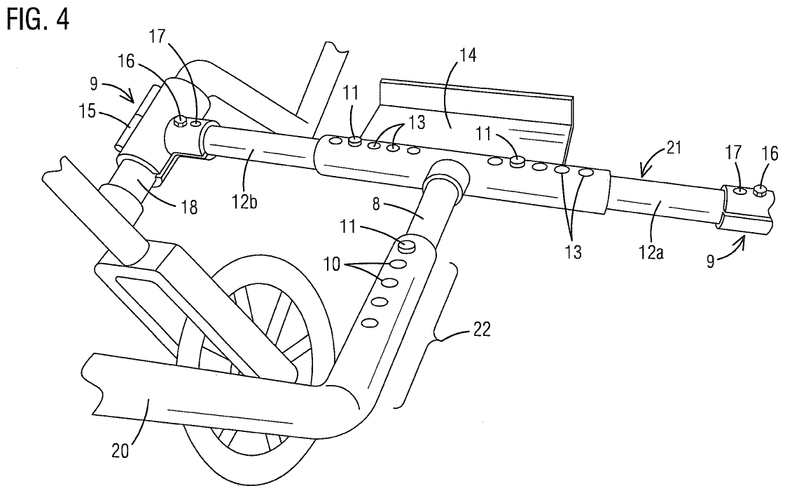

FIG. 4 is a closeup perspective view illustrating the bracket 19 secured to a chassis bar 18 of a wheelchair by clamp 9 secured in a closed position around the chassis bar 18 and leg 12b of the crossbar 21. As described previously, the width of the crossbar 21 can be adjusted by telescoping legs 12a and b sliding inward or outward within the larger circumference inner leg section by one of a plurality of apertures 13 and secured in a desired location by leaf spring snap buttons 11. Similarly, the lower section of the connecting bar 22 has a plurality of apertures 10 and a leaf spring snap buttons 11 in the T-connector to adjust the distance between the wheelchair 1 and the wheeled device 2 depending on the leg length of a user.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described my invention, I claim:

1. An accessory for a wheelchair comprising:
a wheeled device having a wheel, a pedal in a center of the wheel, a post onto which the wheel is mounted at a bottom of the post and a steering wheel on top of the post;
an elongated bar having a top and bottom end with a connector at the top end for attachment to the post of the wheeled device; and
a T-connector at the bottom end of the elongated bar for attachment to a wheel chair, said T connector having a forward bar for connection to the elongated bar and a rear crossbar connected by clamps at each end to an under carriage of a wheelchair.

2. The accessory for a wheelchair of claim 1 wherein the crossbar of the T-connector has at least one section containing a plurality of apertures and a leaf spring snap button for adjusting a width of the crossbar to fit various sizes of wheelchairs.

3. The accessory for a wheelchair of claim 1 wherein the elongated bar has a plurality of apertures proximate the bottom end and the forward bar of the T-connector contains a leaf spring snap button for insertion into one of the plurality of apertures on the elongated bar to adjust the distance between the wheelchair and the wheeled device.

4. The accessory for a wheelchair of claim 1 further comprising a plate extending from a rear of the crossbar of the T-connector to hold a battery or other item.

5. The accessory for a wheelchair of claim 1 wherein the wheeled device is a uni-wheel.

6. An accessory for a wheelchair comprising:
a wheeled device having a wheel, a pedal in a center of the wheel, a post onto which the wheel is mounted at a bottom of the post and a steering wheel on top of the post;
an elongated bar having a top and bottom end with a connector at the top end for attachment to the post of the wheeled device;
a T-connector at the bottom end of the elongated bar for attachment to a wheel chair, said T connector having a forward bar for connection to the elongated bar and a rear crossbar connected at each end to an under carriage of a wheelchair;
wherein the crossbar of the T connector has at least one section containing a plurality of apertures and a leaf spring snap button for adjusting a width of the crossbar to fit various sizes of wheelchairs;
wherein the elongated bar has a plurality of apertures proximate the bottom end and the forward bar of the T-connector contains a leaf spring snap button for insertion into one of the plurality of apertures on the elongated bar to adjust the distance between the wheelchair and the wheeled device.

7. A bracket for connecting a wheeled accessory to a wheelchair, said accessory having a wheel, a pedal in a center of the wheel, a post onto which the wheel is mounted at a bottom of the post and a steering wheel on top of the post, said bracket comprising:
an elongated bar having a top and bottom end with a connector at the top end for attachment to the post of the wheeled device; and
a T-connector at the bottom end of the elongated bar for attachment to a wheel chair, said T connector having a forward bar for connection to the elongated bar and a rear crossbar connected at each end to an under carriage of a wheelchair.

8. The bracket of claim 7 wherein the crossbar of the T-connector has at least one section containing a plurality of apertures and a leaf spring snap button for adjusting a width of the crossbar to fit various sizes of wheelchairs.

9. The bracket of claim 7 wherein the elongated bar has a plurality of apertures proximate the bottom end and the forward bar of the T-connector contains a leaf spring snap button for insertion into one of the plurality of apertures on the elongated bar to adjust the distance between the wheelchair and the wheeled device.

10. The bracket of claim 7 further comprising a plate extending from a rear of the crossbar of the T-connector to hold a battery or other item.

11. The accessory for a wheelchair of claim 7 wherein the wheeled device is a uni-wheel.
